(19) United States
(12) Patent Application Publication
(10) Pub. No.: US 2009/0259574 A1
(43) Pub. Date: Oct. 15, 2009

(54) METHOD AND SYSTEM FOR DETERMINING WHETHER THE ORIGIN OF A PAYMENT REQUEST IS A SPECIFIC E-COMMERCE NETWORK SOURCE

(75) Inventors: Jacob Thomsen, London (GB); Martin Elsman, Lyngby (DK)

Correspondence Address: BUCHANAN, INGERSOLL & ROONEY PC, POST OFFICE BOX 1404, ALEXANDRIA, VA, 22313-1404, US

(73) Assignee: MEDIAKEY LTD., Tortola B.V.I. (BS)

(21) Appl. No.: 12/306,983

(22) PCT Filed: Jun. 29, 2007
(86) PCT No.: PCT/EP2007/005791

§ 371 Date: Feb. 5, 2009

(30) Foreign Application Priority Data
Jun. 30, 2006 (EP) 06013601.7

(51) Int. Cl. G06Q 10/00; G06F 17/30; G06F 17/40

(52) U.S. Cl. 705/30; 707/104.1; 707/5; 707/E17.017; 707/E17.002; 707/E17.044

(57) ABSTRACT

A determination is made whether a purchase has been performed on a website for which a merchant and an acquirer have entered an agreement. At least one web-page associated with the website is equipped with at least one web-bug, which enables collection of information related to one or more customers visiting the website. If the web-page equipped with the web-bug is visited by a customer, a number of pieces of information from the web-bug relating to the customer are stored in a database. The number of pieces of information include a unique customer identifier and an identification of the web-page equipped with the web-bug visited by the customer. If a payment to an account associated with the website that includes the unique customer identifier is received from the merchant by the acquirer, then the stored number of pieces of information are retrieved from the database using the unique customer identifier as a key. Based on the retrieved number of pieces of information, a determination is made whether the payment to the account was performed on the website.

### FIELD OF INVENTION

The present invention relates to a method, a system and a computer readable medium for determining whether a purchase has been performed on a website for which a merchant and an acquirer has entered an agreement.

### BACKGROUND OF INVENTION

Network based commerce activities or e-commerce, which term comprises sales, in particular involving payments, of products or services between customers or payers and merchants performed through a computer network, such as the Internet, by the customer using an electronic communication device, such as a personal computer, a Personal Digital Assistant (PDA), or mobile phone, have gained substantial popularity and prominence in the global economy.

Many products and services are available for sale in a network by merchants. The products may for example be SMS-messages or call time available for mobile phones, mail order gifts, ware house items, and the services may be hotel or travel bookings, and other network based services, e.g. long distance performed server updates, downloads of music, movies and other entertainment, and many other.

However, in order to provide e-commerce, a merchant's website must provide a possibility to pay using a payment solution, which may comprise the use of physical credit, debit, or cash cards, mobile phone, wire, bank transfers, or e-payments such as e-Dankort and e-bank payments.

A payment solution generally necessitates a pre-acceptance of a merchant by a provider of the payment solution. For example, a credit card provider may require that certain terms or conditions are to be met by the merchant in order to establish a merchant payment account with an acquirer, which may be the merchant's bank company.

For example, in order to process a credit card transaction, a merchant must typically establish an account with the acquirer. Because the acquirer takes on a certain financial risk when agreeing to process a merchant's transactions, an application and underwriting process typically takes place before a payment account (often referred to as a ‘merchant account’) is opened. Said payment account may be a credit card account, a debit card account, a physical bank account, or any other account being associated with the merchant. The account can, but need not be, associated with a physical card.

For example, a payment account may be established by an acquirer requiring the merchant to fill out a credit application. Based on the application the Acquirer determines whether the merchant would be a suitable client, e.g. based on information on the type of items being sold on the merchant's website. If so, the account is established and the merchant may begin accepting payments from their customers for their goods or services provided on said website.

A novel type of payment solution provider is an Internet payment service provider (IPSP), who authorizes the payment by performing a transaction in relation to said payment, such as a bank company, a credit card company, or the like. An IPSP is an entity that enters into a contract with the acquirer to shoulder financial responsibility and liability for payment accounts, by which merchants or the website owners are allowed to process and settle Internet transactions.

IPSP's are basically third party resellers for merchants who wish to sell online but who do not have their own merchant accounts. The IPSP resells the online merchant's products and services through its own merchant account, serving as an “umbrella” under which businesses process money under. This does not mean that just anybody can sign up with an IPSP, who have instigated strict terms and acceptable use policies that dictate what kind of businesses are acceptable.

To ensure that online merchants are financially responsible, many payment solution providers, including IPSP's, enforce strict policies on behalf of the acquirer, who shoulder the economic and legal responsibilities of the transaction, by inspecting the online merchant's websites by monitoring. Said policy may be as follows: Prior to signing an online merchant, the acquirer must obtain a detailed business description from the merchant, and must examine the merchant's website to verify that the merchant is operating within the acquirer's jurisdiction; ensure that the merchant is not engaged in illegal activities or any activity that could damage the providers system or brand; retain copies of all relevant website screen shots, and perform an annual website review. In order to remain an online merchant, acquirers must examine the merchant websites on a regular basis.

The above mentioned periodic merchant website examination or review may be performed automatically, and is required for assuring that the website, which has been signed up by the merchant in the account application and approved as such, is in fact existing in the virtual world and selling the product or service, which the merchant is claiming to sell.

The problem for the acquirer and/or payment solution provider is that if payments are being performed on a website selling illegal products by using the payment account for the legal products, the credit card provider and/or acquirer may be liable for legal actions in different jurisdictions according to the laws governing them, e.g. laws such as the US Patriot Act (section 326) for preventing money laundering and terrorist financing through the existing systems. Further, the website may sell products or services that are in violation of the card associations' rules and regulations or in violation of the specific acquirers contract with the card association.

Experience has unfortunately demonstrated to both acquirers and payment solution providers that despite due care by active monitoring some merchants have been able to perform fraudulent acts, i.e. payment account frauds by having established such payment accounts in order to enable payment requests via an approved website, where in fact some or all of the resulting payments requests to said payment account have not originated from said approved website but instead from another co-existing website e.g. selling unauthorised goods, in violation of their merchant account contract. These acts may go unnoticed even when applying the above mentioned strategy of performing automatic or manual periodical website reviews, because the approved site is in existence and is claiming to sell or is actually selling the legal products.

One example may be the following: A fraudulent merchant establishes a legitimate website for selling pet supplies such as pet food, playthings and supplies. He applies as mentioned above for a credit card payment solution on his site with one of the major credit card providers. One of the conditions, which the acquirer and/or credit card provider has set during establishment of the account, is that the merchant must allow for periodic checks of his website, whether it is in fact a website, which does sell the items indicated on the application, or the acquirer may remove the authorization from the merchant to use the payment account.

The acquirer then regularly performs a survey of the sponsored website in question, e.g. every month, quarterly or yearly in order to be assured that said website does indeed display and perform sales of pet supplies, and complies with the other set criteria for using the credit card account in question, e.g. such as displaying the credit card trademark correctly etc.

However, if the fraudulent merchant around the same time of establishing the legitimate pet shop website establishes an illegitimate website, e.g. a pornographic site, and uses the same credit card account for payment upon said pornographic site by displaying the possibility to pay by the credit card in question, such payment request may be processed unnoticed for transaction by the acquirer and/or credit card provider, because the periodical website review has not shown any problems with the approved website.

With the presently available tools, it is not possible to provide a check of the origin of a payment request for websites on the World Wide Web WWW when using dynamically generated HTML (HyperText Markup Language) pages, which are generally used for network sales pages issuing payment requests.

WO 2004/061733 discloses systems and methods for electronically monitoring fraudulent activity comprising monitoring a merchant's payment accounts. However, these have been provided in order to reduce occurrences of payments with non-existing cards performed by the merchants themselves and is not suitable for the above problem, because the check for fraudulent merchants is performed after the fraudulent act has been committed, which does not reduce acquirer and/or payment provider liabilities.

Accordingly, one object of the present invention is to provide a method, a system and a computer readable medium for reducing payment account fraud in relation to an e-commerce source, in particular a website, by providing a reliable check that payments requests to be performed for an established payment account is in fact provided from the specific source, which has been approved and/or is regularly being checked by or for said payment solution provider and/or acquirer.

### SUMMARY OF INVENTION

According to the invention the object is achieved by a method of determining whether a purchase has been performed on a website for which a merchant and an acquirer has entered an agreement, the method comprising the steps of equipping at least one web-page associated with said website with at least one web-bug, said at least one web-bug enabling collection of information related to one or more customers visiting said website; if said at least one web-page equipped with at least one web-bug is visited by a customer then storing a number of pieces of information from said at least one web-bug relating to said customer in a database, said number of pieces of information comprising a unique customer identifier and an identification of said at least one web-page equipped with at least one web-bug visited by said customer; if a payment to an account associated with said website comprising said unique customer identifier is received from said merchant by said acquirer, then retrieving said stored number of pieces of information from said database using said unique customer identifier as a key; based on the retrieved number of pieces of information, determining whether said payment to said account was performed on said website.

Thereby, the method is able to determine whether the customer has performed the payment on a website for which an agreement between the acquirer and the merchant exists. The method is able to determine whether the user has been on the website for which an agreement exists before and/or during and/after the payment. In such a case, the user's unique identifier will be in the database otherwise not. Thus, the method is able to provide confidence to an acquirer that a received payment request does in fact originate from a specific website, e.g. the website for which an agreement has been entered between the merchant and the acquirer.

In an embodiment of the invention, said unique customer identifier comprise information from a cookie on a customer computer visiting said webpage equipped with one or more web-bugs and/or payment card information received from said customer during said payment.

Thereby, the method is able to use either a cookie and/or payment card information such as for example credit card number to identify the customer. Thereby, the customer may be tracked with significant precision on the website.

In an embodiment of the invention, said identification of said at least one web-page equipped with at least one web-bug comprises a URL representing said web-page.

Thus, a URL may be used for uniquely identifying a web-page comprising a web-bug.

In an embodiment, the step of determining whether said payment to said account was performed on said website comprises the step determining whether said unique customer identifier is present in said database.

Thereby, the method is able to determine whether the payment to said account was performed on said website by confirming or invalidating that the unique customer identifier is present in the database.

In an embodiment, the method further comprises a step of associating information regarding said customer received from a plurality of web-bugs via said unique customer identifier.

Thereby, the method is able to handle information from a plurality of web-bugs and associating the information stemming from a single customer to the unique identifier of the customer and thus enabling an improved tracking of the customer before and/or during and/or after a purchase on said website.

In an embodiment, at least one web-page associated with receiving customer payment information is equipped with at least one web-bug.

Thereby, the method is able to determine that the customer has been on a web-page comprising a web-bug and associated with payment insofar that the unique customer identifier exists in the database and the number of pieces of information comprises a unique web-page identifier for a web-page associated with payment. Thus, the method is able to provide a reliable determination that a payment has been performed on a given website.

Embodiments of the present invention also relates to a system corresponding to embodiments of the method.

More specifically, the invention relates to a system for determining whether a purchase has been performed on a website for which a merchant and an acquirer has entered an agreement, the system comprising means for equipping at least one web-page associated with said website with at least one web-bug, said at least one web-bug enabling collection of information related to one or more customers visiting said website; means for storing a number of pieces of information from at least one web-bug on at least one web-page visited by a customer in a database, said number of pieces of information comprising a unique customer identifier and an identification of said at least one web-page equipped with at least one web-bug visited by said customer; means for retrieving said stored number of pieces of information from said database using said unique customer identifier as a key if a payment to an account associated with said website comprising said unique customer identifier is received from said merchant by said acquirer; means for determining whether said payment to said account was performed on said website based on the retrieved number of pieces of information.

The system and embodiments thereof correspond to the method and embodiments thereof and have the same advantages for the same reasons.

Advantageous embodiments of the system are defined in the sub-claims and described in detail in the following.

Further, the invention relates to a computer readable medium having stored thereon a computer program comprising program code means adapted to cause a data processing system to perform the steps of the method according to the invention when said program code means are executed by said data processing system.

### SHORT DESCRIPTION OF DRAWINGS

In the following, the invention will be described in more detail with reference to the schematic drawings, in which:

FIG. 1 shows an overview of a system according to a first embodiment of the present invention;

FIG. 2 shows a system of FIG. 1 providing further details of the transaction responsible entity;

FIG. 3A-3D shows four different examples of source check tags being used with a system according to the present invention; and

FIG. 4 shows a flow chart of one embodiment of a method according to the present invention.

FIG. 5 shows an embodiment of a system according to the invention.

FIG. 6 shows an embodiment of a method according to the invention.

### DETAILED DESCRIPTION OF THE INVENTION

As will be appreciated by the person skilled in the art, the present invention may be implemented in software executed by one or more processors, such as server computers in data communication with other computers via a network, e.g. the software program may be stored in the memory and executed by the CPU of the computer. Further, parts of the software may be executed within different computer devices.

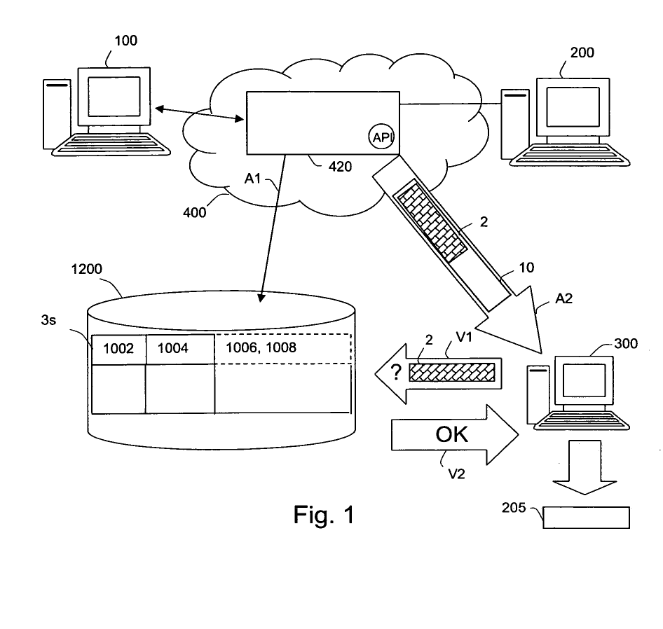

In FIG. 1 is shown a system according to one embodiment of the present invention for reducing payment account fraud in relation to an e-commerce source which payment is performed by a payer using his payer device 100 on a website 420 on the Internet 400 provided by a merchant's web server 200. A device 300 operated by a transaction responsible entity, such as an acquirer or an IPSP, is responsible for the processing of a payment request 10 received by said entity 300, where said payment request is the result of a payment actions performed by said payer on the website 420. The system will provide for a check of the origin of said payment request 10, i.e. that it is in fact originating from a specific source, in this case a website 420 on the Internet, which has been approved during the establishment of a payment account 205 by the acquirer, such as the bank of the merchant providing the website 420 in question. If the check is positive, the entity device 300 may proceed with the transaction in order to ultimately accredit the transaction to the payment account 205 of the merchant. If the check is negative the transaction responsible entity device 300 may have to abort the transaction before it is completed, e.g. by annulling the payment request, and/or at least identify the payment request as not originating from a source which has been approved.

The system comprises means for storing at least a fraud check variable 3s and optionally corresponding identification data, means for assigning a source check tag 2 comprising said fraud check variable 3a relative to said payment request 10; and means for verifying that said source check tag 2 relating to a payment request 10 is originating from said specific source 420.

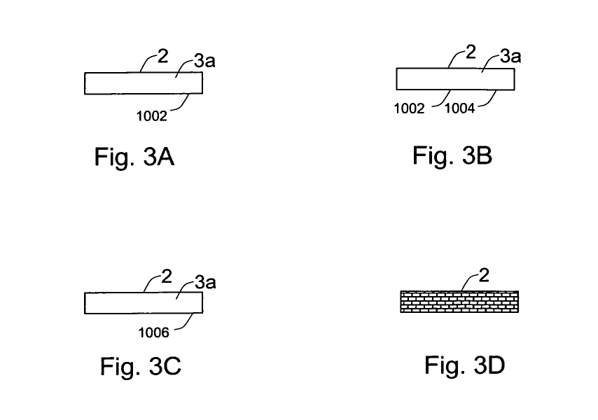

Two general embodiments of tags according to the invention have been envisioned, a first using a fraud check variable 3a comprising at least a payer fraud risk potential 1002 and discussed in relation to FIG. 1, a second using a fraud check variable comprising source information 1006, and the combination of these two embodiments may also be conceived. However, alternatives may be conceived, comprising tags with fraud check variables of different kinds suitable for identifying the source of a payment request or the payment request per se. The tag 3 will be further described below, and in relation to FIGS. 3A to 3D.

As shown in FIG. 1 the system is in communication A1 with said website 420 e.g. by using the Internet or by a separate computer link in order to provide storing means according to the present invention using a verification database 1200 for storing records of fraud check variables 3s, and optionally further corresponding information, said variable e.g. comprising a payer fraud risk potential 1002, payment identification number 1004, source information 1006 and/or user fraud information 1008, relating to the different payment requests issued by the website 420.

Further, said system has assigning means within the website 420 for example by specification of the standard Open Market TRANSACT Application Program Interface or API, or a separate API, e.g. within the Domain field, assigning a source check tag 2 accompanying the payment request 10, which may also include a payment identification number. Alternatively, the assigning may be performed remotely from said website, e.g. as a transcript from said verification database 1200 provided separately from said payment request to said entity 300.

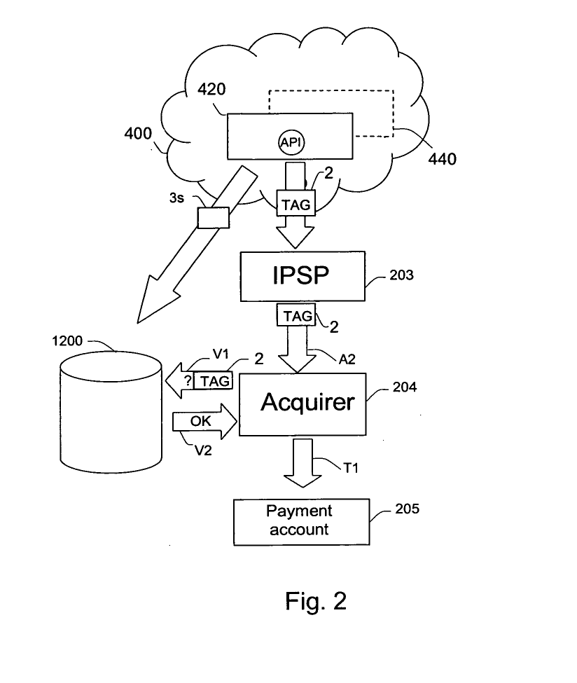

Said system is further in communication with said device 300 of a transaction responsible entity, which may be an acquirer, e.g. said merchant's bank holding the payment account 205 used for payment on his website, and/or a payment solution provider, e.g. a credit card provider or an IPSP. A more detailed description of the transaction responsible entity 300 will follow below in relation to FIG. 2. The system is in communication with said entity device 300 e.g. by using the Internet or by a separate computer link in order to provide verification means utilizing said verification database 1200 for verifying that a payment request, received by said entity 300, originates from an approved website 420.

When performing a sale upon said website 420, several subsystems may be in operation for the website in question, generally comprising a catalogue subsystem using a shopping card database, where the shopping cart data is passed on to a purchase subsystem, if the payer decides to purchase the items of the shopping cart. The purchase subsystem comprises a transaction database, the data of which is passed on to a payment request 10 for use within a transaction process or subsystem, when the user is using a payment solution provided on the website, e.g. using his credit card for payment. The transaction process generally includes an authentication of the payment request 10, e.g. by the credit card provider or by an IPSP, before settling the amount with the payment account 205. The authentication may include different check-ups, such as a verification of the transaction details, credit card authentication, etc. One such check-up may be a user fraud check-up, another may be a merchant payment account fraud check by a method according to the invention.

In FIG. 1 an encrypted source check tag 2 is attached to said payment request 10 during the transmittal A2 of the assigned tag 2 to the entity device 300. However, as mentioned above an alternative is shown in FIG. 2 where the tag 2 is assigned independently from the payment request, either before, during, or after the transmittal of said payment request to said entity device for transaction processing. In the latter case, preferably, the data within the tag further comprises at least a payment identification number 1004 in order to identify the relevant payment request, for which the tag 2 is belonging, which has arrived or will be arriving to the transaction responsible entity device 300.

In FIG. 1 a stored entry in the verification database 1200 comprises a fraud check variable 3s, and optionally further data such as payer fraud information. Preferably, the database 1200 contains several records, one for each payment request issued and/or one for each merchant website being approved, depending on which of the two main embodiments is being utilized. The device operating the database 1200 is preferably adapted for handling several storing and verification processes at any time, and is suitable for handling a large number of records at a given time. Other means of storing may be conceived, all available for the skilled person, e.g. a computer listing, a running table, a website available database, while using different computer storing means, such as a hard disk, a diskette, or the like.

Said verification database 1200 may preferably be operated by a CPU, such as a separate computer device (not shown). The computer device (not shown) for handling the verification database 1200 may be operated by a source check service provider, and may be provided remotely from said transaction responsible entity's device 300, where the communication therebetween may be performed through the Internet or by a separate communication link. Alternatively, the verification database is provided within said transaction responsible entity's device 300. In any case, the verification database 1200 is preferably provided remotely from the merchant server 200 in order to safeguard the stored entries from any fraudulent attempt of trying to modify these.

A new source check tag is preferably generated each time a payment request is issued by the purchase subsystem of the website. Each tag generated is not identical with every other tag because the data therein, i.e. the fraud check variable is a variable. However, it is not necessary that each tag is unique, because fraudulent attempts of re-using a tag for further payment requests would have a lower probability of success even when only applying a binary variable different from each other. However, clearly, using a multitude of variables, even to unique variables decreases this probability even further.

The assigned and stored fraud check variable 3a, 3s may comprise a payer fraud risk potential 1002, e.g. as discussed above a user fraud risk potential as described in EP application no. 06075254.0 being provided based on analysis of user behaviour within said website. In a simple form, the fraud risk potential is an integer from 0 to 9, e.g. level 0 to level 9, indicating low fraud probability and high fraud probability, respectively. Other levels and their respective meaning may be conceived, e.g. binary, tri-level or multi-level indicator. The payer fraud risk potential 1002 may also be in the form of a colour level indication, e.g. green, yellow, red, or the like, as may be conceived. Preferably, a multi-level variable is used, because this will provide added security to the system and method according to the present invention, since the risk that a matching variable of a merchant will have been stored within the verification database will then be lower.

Alternatively, the fraud check variable 3a, 3s may be a randomly generated variable, e.g. a number and/or letter combination, only relevant for providing a variable for indicating attempted payment account fraud. However, a further advantage of assigning a fraud check variable, which indicates the potential for user fraud, is that it conveys more information than only the possibility of payment account fraud by a merchant, it also conveys the information of the potential of user fraud for each payment request issued by the website in question, which information may be used for said above mentioned user fraud check-up in relation to said transaction.

Alternatively or in combination with the above mentioned payer fraud risk potential, the fraud check variable may comprise source information 1006, which may comprise a unique source identification number or reference number, e.g. for retrieval of further corresponding data relating to the source, e.g. stored within said verification database. This may be merchant name, contract name, website name, products sold within said website, etc. The source information 1006 may preferably comprise a variable obtained within the website during the sale, e.g. a snap shot of the website, e.g. in a TIFF, JPG or other picture format, or a variable generated on the basis of the payment request in question, e.g. a given combination of integers and/or letters or the like.

Observe, that the data within the verification database may comprise further data apart from said fraud check variable, e.g. associated information, which often require more storage space than the fraud check variable. Accordingly, said tag may be used for retrieval of extensive information in a verification response for a data transfer to said entity device 300.

The tag 2 within the payment request 10 is relayed A2 to said transaction responsible entity 300. The entity 300 transmits at least the tag 2 comprising the encrypted data to the source identification service provider device (not shown) by a verification request V1 for verification of whether the payment request does in fact originate from a website, which has been approved by the acquirer. The data contained within the tag 2 is decrypted and used for a comparison whether they match the data stored within the verification database 1200 for an identification of the source website, from which the corresponding payment request originated. If the data tag 2 is positively verified using the verification database 1200, the source identification service provider device transmits a positive verification response V2 to the entity 300, and the processing of the transaction may continue by debiting said payment account 205. Additional data copied from the verification database may preferably be transmitted with said verification response V2.

Different forms of determinations may be employed depending on the content of the tag 2. Firstly, the determination may be positive if the assigned fraud check variable in the tag 2 finds a matching stored variable within the database, which is suitable e.g. for very different variables being used for identification, e.g. unique variables. Secondly, the determination may be positive, if the fraud check variable comprises a payment identification number and this is used for retrieving a matching fraud check variable. This is suitable, when there is a limited variation level within the fraud check variable, e.g. ten different levels. Thirdly, the determination may be positive, if the assigned fraud check variable at least matches a selection of stored fraud check variables, e.g. a predetermined selection of variables provided for a given source. This is suitable, when only a few levels of variation is available for the fraud check variable, e.g. when limited assignment space is available for the tag, when being provided with a payment request for example.

As shown in FIG. 2, the tag 2 may travel through a chain of devices comprising an IPSP device 203 and an acquirer device 204 after being issued by the source. Said chain may be longer or shorter, depending on the number of devices the payment request is to be processed by. It may be only one device, e.g. the acquirer device 204 or an IPSP or alternatively a separate source check service provider (not shown), who is assigned the responsibility to provide one or more of the checks in relation to the payment request, i.e. the IPSP 203 or another entity may send the verification request V1. There may be more than two devices in the chain, e.g. when the source check is outsourced to a provider thereof. Generally, it is the acquirer, who is shouldering the financial and legal responsibilities, and thus the acquirer device 204 is verifying any tag 2 for further processing of payment requests.

In FIG. 2, the transaction responsible entity is the acquirer device 204, who is provided a source check service by a source check provider device (not shown), e.g. hosting a verification database 1200. The source check tag 2 comprises a non-encrypted fraud check variable comprising payer fraud risk potential and corresponding payment identification number of a payment request (not shown) issued by said merchant website 420 at the same time as the fraud check variable 122 is stored within the verification database 1200. The tag 2 is transmitted by a computer link or the Internet to an IPSP device 203, who handles initial processing of the corresponding payment request, whereupon the tag 2 is transmitted to said acquirer device 204, independently from the corresponding payment request.

The acquirer relays the tag 2 comprising the non-encrypted data to the source identification service provider in a verification request V1 for verification of whether the corresponding payment request does in fact originate from a website, which has been approved by the acquirer. The data contained within the tag 2 is used for a comparison whether they match the data stored within the verification database 1200 for an identification of the source website, from which the corresponding payment request originated. If the data tag 2 is positively verified using the verification database 1200, the source identification service provider device transmits a verification response V2 to the acquirer 204, and the processing of the transaction may continue e.g. by debiting said payment account 205. If not positively verified, the acquirer 204 may choose to abort the processing of the transaction, and he may contact the merchant for an explanation of the inconsistency.

As shown, the verification means may be provided remotely from the IPSP device 203 and the acquirer device 203, respectively. Alternatively, the verification may be performed by either of these entities, e.g. by providing the source identification service provider processor 102 integrally therewith.

Alternatively, a fraud check tag may effectively travel from the source identification provider processor to acquirer device 204, the tag comprising data for identifying the relevant the payment request originating from said website 452. Accordingly, the IPSP processor 203 receives the payment request A2 without said source check tag 2, and relays said payment request on to the acquirer device 204, which transmits a verification request V1 comprising at least said source check tag 2 to the source identification service provider device for verification thereof, i.e. that the corresponding payment request does in fact originate from the website in question, and proceeds as explained above

As shown in FIGS. 3A to 3D, four different examples of said data tag 2 is shown, which tag may comprise data of different types, depending which of the two main embodiments are being used, and of the conditions under which they are to be used. Alternative tags are conceivable, comprising e.g. further data for providing said variable, or data for conveying further information, as required.

As shown in FIG. 3A, the source check tag 2 comprises a first type of fraud check variable 3a comprising a payer fraud risk potential 1002, e.g. obtained by monitoring and recording events comprising user induced events within the website during the sale leading to the issued payment request. This tag is suitable for assigning by attaching to a payment request, because the data of the tag does not convey information as to which payment request it relates to.

As shown in FIG. 3B, the tag 2 comprises a second type of fraud check variable 3a comprising a payer fraud risk potential 1002, and the corresponding payment identification number 1004, in which case the tag may be assigned independently from the payment request, to which it relates, see the description in relation to FIG. 2.

As shown in FIG. 3C, the tag 2 comprises a third type of fraud check variable 3a comprising source information 1006 as described above, which is suitable e.g. when the acquirer is using a verification database 1200 within his device 204, and the tag is further used for retrieving pre-stored merchant and/or website data within said database for further processing of the payment request. This third tag type is suitable for encryption, see FIG. 3D, because with encryption, the tag is not easy to copy for other illegal payment requests.

In FIG. 3D, as indicated with a bar design, the data comprised within the tag 2 is encrypted when the tag is assigned, where the data may comprise any of the above mentioned information. Different conventional techniques for encryption and the following decryption is available, and the skilled person will know how to apply this in an appropriate way, and thus the techniques will not be discussed further herein, except for mentioning a few alternatives: Secret key (symmetric), public key (asymmetric) e.g. S/MIME, hash functions, Diffie-Hellman protocols etc. Decryption generally takes place in relation to the verification process, either by the transaction responsible entity device 300, e.g. using a private key cryptography technique, or by the device comprising the verification database 1200. Encryption/decryption is in particular advantageous, when the tag may be easily copied for each new payment request, e.g. using exclusively source information 1006. By cryptography, the entity device 300 may be confident that information intended for his use only may be safeguarded.

Any of the tag types shown in FIGS. 3A to 3C may comprise further information, e.g. payer fraud information relating to the data providing the basis for the payer fraud risk potential. Any combination of payer fraud risk potential, payment identification number, source information and/or payer fraud information may also be perceived.

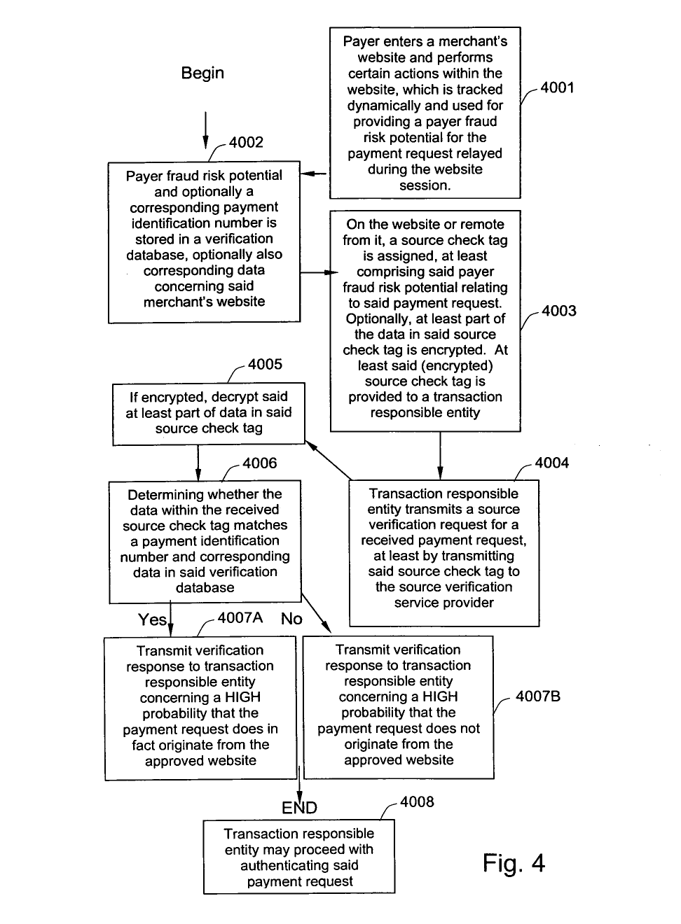

In use, see FIG. 4, a method according to the invention is being performed in relation to a sales session for a payer within a website. In 4001a payer enters a merchant's website and performs certain actions within the website, which is tracked dynamically and used for providing a payer fraud risk potential for the payment request relayed during the website session, e.g. as disclosed in European Patent application no. 06075254.0.

In 4002 according to a storing step of the present invention, said payer fraud risk potential and optionally the corresponding payment identification number is stored in a verification database, optionally comprising also corresponding data concerning said merchant's website. A new entry, such as a new record in the verification database is created e.g. by using a payment identification number identifying each payment request from said source.

In 4003 a source check tag is assigned according to the assigning step of the present invention on the website or remote from it, at least comprising said payer fraud risk potential relating to said payment request. Optionally, at least part of the data in said source check tag is encrypted. At least said (encrypted) source check tag is provided to a transaction responsible entity. If encrypted, decrypt said at least part of data in said source check tag.

In 4004 to 4007 is described a verification step according the present invention. In 4004 the transaction responsible entity transmits a verification request for a received payment request, at least by transmitting said source check tag to the source verification service provider. In 4005, if the tag is encrypted said at least part of data in said source check tag is decrypted for the verification of the data contained within. In 4006 it is determining whether the data within the received source check tag matches a payment identification number and corresponding data in said verification database. If it is a positive determination, in 4007A a verification response is transmitted to transaction responsible entity concerning a HIGH probability that the payment request does in fact originate from the approved website. If it is a negative determination, in 4007B a verification response is transmitted to transaction responsible entity concerning a HIGH probability that the payment request not originate from the approved website. The method according to the invention ends here.

In 4008 the transaction responsible entity may proceed with authenticating said payment request.

The step of storing may be performed simultaneously, later or before the step of assigning. The step of assigning may be performed continuously, e.g. a payer fraud risk potential is used for the fraud check variable, which potential changes over time, until a payment request is issued, whereafter the storing step is performed or vice versa.

Another example of a method for checking that the origin of a payment request is a specific source in order to reduce payment account fraud in relation thereto said method comprises the following steps: storing a fraud check variable being determined based on user behaviour with said source in relation to a payment providing said payment request and a corresponding payment identification number of said payment request; associating a source check tag with said payment request, said source check tag comprising at least said payment identification number, and verifying that said payment request comprising a source check tag is originating from said specific source by locating a stored fraud check variable corresponding to said payment identification number and matching said stored fraud check variable with said stored fraud check variable.

Yet another embodiment provides for the fraud check variable being time variable e.g. it may change over time, e.g. during the time period in which the sale is being performed and/or after, in the database depending on events happening before and/or after the payment request has been issued, such that it is only a current, say within 24 hours, fraud check variable assigned to a tag which matches the variable saved within the database. This would provide extra security, because the assigned and stored variable must match, and the way it varies over time is not apparent to the merchant.

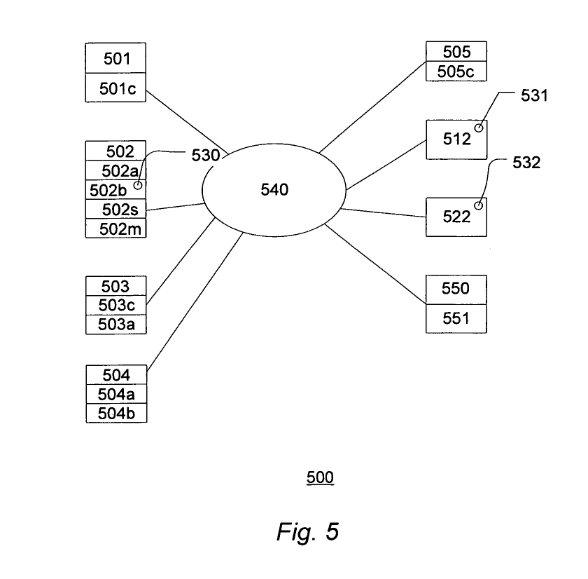

In FIG. 5, an embodiment of a system for determining an identity of a source is illustrated. The determining of an identity of a source (such as for example an Internet website provided by a merchant) may be used to, for example, reduce and/or remove the problem of payment account fraud as disclosed, for example, in the background of the present invention.

The system 500 comprises a customer 501 with a customer computer 501c, a merchant 502m and a merchant source 502 such as an internet website comprising one or more web pages 502a and 502b hosted e.g. on a server 502s, an acquirer 503, such as e.g. a bank, with an acquirer computer 503c, and means 504 for storing a number of pieces of information relating to the customer's 501 behaviour in relation to said website 502 such as for example a server comprising peripherals such as one or more CPUs, a memory such as RAM, one or more hard-disks, one or more optical discs, a bus connecting said peripherals. Said server 504 may, for example, be situated at the bank 503 and/or at a provider of payment account fraud prevention. Additionally, the system 500 may comprise a “middle-man” 505, such as an IPSP, and an IPSP computer 505c between the merchant 502 and the acquirer 503. Further additionally, the means 504 may be situated at the IPSP 505. The system may be interconnected e.g. via the Internet and/or via WLAN, LAN, and/or any other type of communication network 540.

The server 504 may, for example, track the customer's 501 whereabouts on the source 502 using e.g. information received from one or more web-bugs 530 and/or the like, placed on one or more of the web-pages 502b of the website/source 502. Information from the one or more web-bugs 530 may be stored, e.g. on a hard-disk connected to the server 504, in a first parameter 504a representing the customer's 501 whereabouts on the website/source 502. The information from the one or more web-bugs 530 received by the server 504 may, for example, comprise a first uniform resource locator (URL) representing the web-page 502b at which a web-bug 530 is placed and which web-page is and/or has been visited by the customer. Said web-bug may, for example, be activated by the customer 501 visiting the web-page 502b containing a web-bug 530. The URL information representing the one or more web-pages comprising web-bugs 530 visited by the customer may stored in the first parameter 504a by said server 504.

A web-bug 530 may be an object embedded in one or more web pages 502b on a website 502 and/or in an e-mail (such as for example a confirmation email and/or a payment receipt email). A web-bug 530 may be invisible to a customer visiting the web page 502b and/or reading the email. The web-bug 530 may allow checking that a customer has visited and/or viewed the web page 502b and/or e-mail.

A web bug 530 may, for example, use HTML iframe, style, script, input link, embed, object, and/or other tags to track a customer's usage of the web pages 502b on a website 502. When the customer opens a web page 502b comprising a web bug 530 on the merchant's server 502s with e.g. a graphical browser and/or e-mail reader, the image and/or other information is downloaded to the customer's computer 501c. This download requires the customer's web browser to request the image from the merchant's server 502s at which the image is stored, thereby allowing the server 502s to take notice of the download and communicate this information to the server 504.

Alternative names for web-bugs may be web beacon, tracking bug, pixel tag, clear gif, widget and/or PattyMail.

Additionally, the first parameter 504a may, for example, comprise information on the speed at which a customer navigates through a website and/or customer country information and/or information on payment method selected by the customer and/or information on customer support requests.

Additionally, the first parameter 504a may comprise a customer fraud ranking e.g. based on the websites/web-pages visited by the customer before and/or during and/or after e.g. a purchase of an item and/or service on the website 502.

Additionally, the first parameter 504a may, for example, further comprise information voluntarily filed by the customer 501 on one or more web-pages 502a, 502b of said website 502 and/or information on the customer's handling of information e.g. in relation to a payment transaction on said website 502 and/or the customer's handling of information in relation to for example other websites 512, 522 visited before and/or after said payment transaction.

Based on the URL information stored in the first parameter 504a representing the one or more web-pages 502b comprising web-bugs 530 visited by the customer 501, on the website 502, an identity of the website at which the customer is currently present may be determined. The determination may be performed, for example, in connection with a purchase performed by the customer on the website 502. Alternatively or additionally, the determination may be performed each time new information is added to the first parameter 504a, for example information added to the first parameter 504a stemming from a web-bug 530. Alternatively or additionally, the determination may be performed at any given time. The determination may, for example, provide a URL representing the website 502 based on the URL information stemming from the one or more web-pages 502b comprising web-bugs 530 visited by the customer 501. Alternatively or additionally, the determination may provide a name of the website based on the URL information stemming from the one or more web-pages 502b comprising web-bugs 530 visited by the customer 501.

The merchant 502m may, for example during establishment of an account 503a at the acquirer 503, have informed the acquirer 503 about an announced identity of a website 502, e.g. a second URL and/or a name representing the website 502, at which the merchant would like to use the account e.g. for receiving payments from customers purchasing services and/or products from the website 502. For example, the merchant may have informed the acquirer that the respective account 503a would be associated with customer purchases on a website 502 with a given URL and comprising a number of web-pages. 502a, 502b each with their respective URLs.

Further, during establishment of the account 503a, the acquirer 503 and the merchant 502m may, for example, agree that the account 503a is to be used substantially exclusively in relation with the website 502. Alternatively, any other type of agreement may be made between the merchant 502m and the acquirer 503.

Additionally, during establishment of the account 503a, the acquirer 503 may request the merchant 502m to install a number of web-bugs 530 on web-pages 502b of the website 502. The web-bugs may be provided by the acquirer. Alternatively or additionally, the web-bugs 530 may be provided by the merchant 502m. Alternatively or additionally, the web-bugs may be provided by the server 504. Alternatively or additionally, the web-bugs 530 may be provided by a third party.

The web-bugs may, for example, be installed on one or more of the merchant's web-pages by the merchant e.g. under the guidance of the acquirer and/or a provider of payment account fraud prevention.

The announced identity may, for example, be communicated from the acquirer computer 503c to the server 504 e.g. via email and/or letter and/or telecommunication link such as an optical telecommunication cable and/or via WLAN and/or Bluetooth and/or any other type of communication means. The announced identity provided by the merchant 502m regarding the website 502 associated with the account 503a may be stored in a second parameter 504b on the server 504.

When a determination of said URL from said first parameter 504a has been completed e.g. after a purchase by the customer 501c at a website 502 or at any other time, the determined identity (URL) of the website contained in the first parameter 504a may be compared to the announced identity (URL) contained in said second parameter 504b. The comparison may be performed on the server 504. From the comparison, a relation between the determined website identity (URL) and the announced website identity (URL) may be determined.

For example, the server 504 may determine, based on the comparison, that the announced identity of the website is (substantially) identical to the determined identity of the website. Thus, the server 504 may ensure the acquirer 503 that the account 503a is used in relation to the announced URL and thus that the merchant uses the account 503a in accordance with the terms agreed with the acquirer 503.

For example, the merchant 502m may have announced to the acquirer 503 that the account 503a would be associated with trade of products and/or services on a first website with a first URL. The determined identity, based on the URL information received from the one or more web-bugs 530, of the website 502 may have revealed said first URL. Thus, the comparison may reveal that the announced and the determined identities of the website are identical.

Alternatively, the server 504 may determine, based on the comparison, that the announced identity/URL of the website is different from the determined identity/URL of the website. For example, the merchant 502m may have announced to the acquirer 503 that the account 503a would be associated with trade of products and/or services on a first URL. The server 504 may, however, determine that the website is associated with a second URL. In this case, the server 504 may inform the acquirer 503 that merchant 502m does not use the account 503a in accordance with the terms agreed with the acquirer 503.

The result of the comparison may be transmitted from the server 504 to the acquirer computer 503c e.g. via email and/or letter and/or telecommunication link such as an optical telecommunication cable and/or via WLAN and/or Bluetooth and/or any other type of communication means. The acquirer 503 may determine a suitable action based on the result transmitted by the server 504.

For example, if the merchant 502m uses the account 503a on the agreed terms, the acquirer 503 may refrain from performing any actions. Alternatively, if the merchant 502m, for example, uses the account 503a on non-agreed terms, the acquire 503 may, for example, close the account 503a and/or change the terms of the merchant's 502m account 503a and/or charge the merchant an additional fee for usage of said account 503a.

In an additional embodiment, the server 504 performs the determination of identity of the website 502 based on the information from the one or more web-bugs and stores the determined identity in said first parameter 504a.

In an additional embodiment, the merchant 502m may inform the acquirer 503 about a number of first URL's, each of said number of first URLs representing a web-page contained in said website 502 (i.e. the number of first URLs may be uniquely distinct from each other) at which the merchant would like to use the account e.g. for receiving payments from customers purchasing services and/or products from the website 502.

The number of first URLs may, for example, be communicated from the acquirer computer 503c to the server 504 e.g. via email and/or letter and/or telecommunication link such as an optical telecommunication cable and/or via WLAN and/or Bluetooth and/or any other type of communication means. The number of first URLs provided by the merchant 502m regarding the web-pages 502a, 502b associated with the account 503a may be stored in list in the second parameter 504b on the server 504.

When a customer visits a web-page 502b comprising a web-bug 530 on the website 502, a first URL representing said web-page 502b is transmitted from the merchant computer 502c to the server 504 via web-bug 530. The received first URL is stored in the first parameter 504a representing said customer. If the customer 501 initiates a purchase on the website 502, information regarding the purchase may be transmitted from the merchant computer 502c to the server 504 and the server 504 may in response compare the first URL received from the merchant's computer 502c to the list comprising a number of first URLs contained in the second parameter 504b. If the first URL received from the merchant's computer 502c is represented in the list contained in the second parameter 504b, then the server 504 may ensure the acquirer 503 that the account 503a is used in relation to the announced website 502 and thus that the merchant uses the account 503a in accordance with the terms agreed with the acquirer 503. Alternatively, if the first URL received from the merchant's computer 502c is not represented in the list contained in the second parameter 504b, then the server 504 may provide information to the acquirer 503 that the account 503a may be used in relation to other websites than the website 502 and/or web-pages than the announced web-pages and thus that the merchant may use the account 503a not in accordance with the terms agreed with the acquirer 503. In such a case, the acquirer 503 may, for example, determine to for example examine the website 502 in person.

In an additional embodiment, at least one web-bug is placed on a web-page 502b of the website 502 at which customers provide payment information in relation to a purchase performed on the website 502. A web-bug may, for example, be placed on a web-page 502b on which the customer enters credit-card information. Alternatively or additionally, a web-bug may be placed on a web-page 502b at which the customer provides shipping information. Alternatively or additionally, a web-bug 530 may be placed on a web-page 502b at which the customer acknowledges an order. Alternatively or additionally, a web-bug 530 is placed on a web-page 502b at which the customer may read a purchase confirmation notice.

Thereby, the server 504 is able to ensure the acquirer that the payment is performed on the website 502 insofar that the server 504 determines that the determined URL is (substantially) identical to the announced URL and/or that the server determines that the web-page URL is (substantially) identical to an item in the list of a number of web-page URLs.

In an additional embodiment, when a purchase is performed by the customer 501 on said website 502, a payment transaction related to said purchase is initiated by the merchant's server 502s. During the payment transaction initiation, the merchant's server 502s may transmit, e.g. via the Internet and/or via any other network, an indication to the server 504 that a transaction is occurring; the merchant's server 502s may further provide information that the transaction is performed between the merchant 502m and the customer 501. The server 504 may return the first parameter 504a comprising a determined identity, e.g. in the form of an URL of the website 502, to the merchant's server 502s. The determined identity in the first parameter 504a transmitted to the merchant server 502 may be encrypted partly or completely or may not be encrypted. The encryption may be performed e.g. via a public/private key pair exchanged between for example the acquirer computer 503c and the server 504. In case the first parameter 504a is encrypted, the merchant may be prevented from modifying the URL information comprised in the first parameter 504a.

The merchant's server 502s transmits payment transaction information and the first parameter 504a to the acquirer computer 503c. The payment transaction may comprise information on e.g. a customer bank 550 and a customer account 551 and the merchant's bank 503 and the merchant's account 503a between which accounts a fund transfer will take place. If the first parameter 504a is encrypted partly or completely, the acquirer computer 503c decrypts the first parameter 504a in order to retrieve the determined identity using a private key from the private/public key pair exchanged with the server 504.

Further, the acquirer computer 503c may compare the determined identity contained in the first parameter 504a with the announced identity contained in the second parameter 504b of the website 502 and determine a relation between said determined identity and said announced identity i.e. the acquirer computer 503c may determine whether the determined identity is (substantially) identical to the announced identity. Based on the relation, the acquirer 503 may perform a number of steps e.g. in relation to the terms on which the merchant 502m has obtained the account 503a. Alternatively or additionally, the acquirer 503 may decide to, for example, acknowledge the payment transaction if the determined identity contained in the first parameter 504a is (substantially) identical to the announced identity contained in the second parameter 504b. Alternatively or additionally, the acquirer 503 may decide to, for example, reject the payment transaction if the determined identity is (substantially) different to the announced identity.

In an additional embodiment, the merchant's server 502s transmits payment information and the determined identity contained in the first parameter 504a to an IPSP computer 505c. The IPSP computer 505c performs payment transactions between the customer account 551 and the merchant account 503a, possible using one or more IPSP accounts. Additionally, the IPSP computer 505c forwards the determined identity to the acquirer computer 503c. The acquirer computer 503c may decrypt the determined identity contained in the first parameter if it is encrypted, and further compare the determined identity and the announced identity. Based on the comparison, the acquirer computer 503c may determine a relation between the identities contained in 504a respectively 504b. Based on the relation determined by the acquirer computer 503c, the acquirer 503 may perform a number of steps e.g. in relation to the terms on which the merchant 502m has obtained the account 503a.

In an additional embodiment, if the customer is linking to the website 502 from another website 512 also comprising one or more web-bugs 531 by which the server 504 may track the customer 501, then the server 504 may also store information from the web-bugs 531 in said first parameter 504a. Additionally or alternatively, if the customer links, from the source 502, to a third source 522 comprising one or more web-bugs 532 by which the server 504 may track the customer 501, then the server 504 may also store information from the web-bugs 532 at source 522 in said first parameter 504a.

Thereby, depending on the websites and/or web-pages 502, 502a, 502b, 512 and 522 visited by the customer, the server 504 may store information regarding the whereabouts of the customer before and/or during and/or after the customer visiting the source 502, said information stemming from web-bugs such as 530, 531, and 532.

The additional information stored in the first parameter 504a may for example be used to estimate a fraud ranking of the customer 501.

For example, the server 504 may store information on the customer whereabouts before and/or during and/or after a purchase of an item and/or service at the source 502. Alternatively or additionally, the server 504 may store information on the customer whereabouts continuously i.e. updating the information stored in the first parameter 504a each time new information from one or more web-bugs 530, 531, 532 is received.

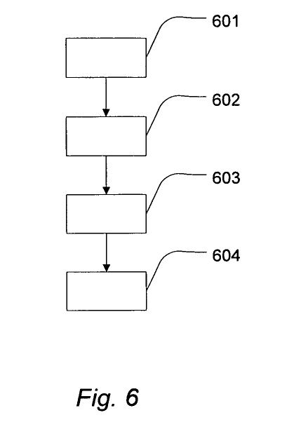

In FIG. 6, an embodiment of a method of determining an identity of a website is illustrated.

In step 601, a merchant 502m enters an agreement of redemption with an acquirer 503 for one or more websites 502 at which payment for products and/or services is to be received. As part of the agreement, the merchant 502m may be required to equip the one or more websites 502 with one or more web-bugs 530. As an example, one or more web-pages 502b associated with the website 502 may be equipped with one or more web-bugs 530. The one or more web-bugs 530 may enable tracking of a customer's 501 behaviour before and/or during and/or after a purchase of a product and/or service on said one or more websites 502.

In step 602, information from one or more web-bugs 530 visited by the customer 501 on the website 502 is transmitted from the merchant's server 502s to a server 504 in which server said information is stored in an electronic medium such as for example as a parameter 504a in a database. The information from the one or more web-bugs may e.g. comprise a unique web-page identifier such as an URL for the web-page containing the web-bug and being visited by the customer. A relationship between the information received from one or more of web-bugs 530 for a given customer 501 is achieved by a unique customer identifier. Said unique customer identifier may, for example, be made by equipping the customer's computer 501c with a cookie.

In step 603, the customer purchases a service and/or product from the website 502. The customer may, in relation to the purchase, visit one or more web-pages associated with payment. The one or more web-pages associated with payment comprise at least one web-bug. The at least one web-bug on the one or more web-pages associated with payment collects information regarding the customer 501 such as a unique identification number on the customer's means of payment (e.g. a credit card number). Additionally, information on the price of the purchased service and/or product may be collected by the at least one web-bug. Additionally, information on a unique web-page identifier may be collected. The information collected by the web-bug may be transmitted to the server 504 and stored in the electronic medium.

In step 604, the acquirer server 503s receives payment redemption from the merchant server 502s in relation to a purchase performed by the customer 501 on the website 502. The acquirer 503 and/or acquirer server 503s may contact the server 504 in order to check on which website the purchase has been performed. The acquirer may, e.g. through the acquirer server 503s, use the customer information, such as the unique customer identification number and/or the unique customer identifier, as a key to retrieve information regarding the customer in the electronic medium (e.g. database) of the server 504. In response, the server 504 may inform the acquirer 503 about the website 502 at which the purchase has been performed insofar that the purchase is performed on a website registered by the merchant 502m at the acquirer 503 and equipped with one or more web-bugs.

Thus, the acquirer 503 may be ensured that the payments that are redeemed by the merchant 502 stem from the websites 502 for which an agreement of redemption has been entered. The acquirer 503 and/or others may perform an ongoing monitoring of the websites 502 for which an agreement has been entered such that the acquirer 503 may be ensured that the websites 502 are used for the purpose agreed upon in the agreement. The acquirer 503 may, for example, check the websites 502 for which the agreement has been entered once every month.

In an alternative embodiment, step 604 may comprise generating, in the electronic medium (database), an encrypted information-package comprising the personal information and other information collected by the one or more web-bugs 530, using an encryption key known to the acquirer, but not known by the merchant. Said information package may be sent from the electronic medium (database) to the merchant server 502s, and transmitted from the merchant server 502s to the acquirer computer 503c together with the payment redemption. The acquirer server 503c may decrypt the information package and verify that the payment redemption is corresponding to the payment information in the information package and thus the acquirer 503 may be ensured that the payment has taken place on the given website.

In an alternative embodiment, the merchant server 502s may transmit a URL to the encrypted information package which may then, for example, be downloaded and decrypted by the acquirer server 503c.

In an alternative embodiment, the customer information collected by the one or more web-bugs in step 603 may also comprise a unique sales reference generated by the merchant server 502s.

In an alternative embodiment, the one or more web-pages associated with payment and equipped with one or more web-bugs 530 may be provided by the acquirer 503. The acquirer 503 may use the unique customer identifier and/or unique identification number (e.g. credit card number) as key to retrieve information from the electronic medium (database) regarding information on which website(s) (comprising web-bugs) the customer has visited before and/or after visiting the payment website. Thereby, the acquirer 503 may be ensured that the payment corresponds to a purchase performed on a websites 502.

In an alternative embodiment, the retrieving of customer information from the electronic medium in step 604 may further comprise an analysis of the customer's behaviour before and/or after a purchase of a product and/or service on the one or more websites 502. Based on the result of the analysis, the acquirer 503 and/or other may determine whether the customer's behaviour on the website corresponds to a behaviour of a de facto purchase on the website 502. The analysis may, for example, determine a likelihood that the purchase is attempted fraud based upon the information received from the one or more web-bugs on the one or more websites 502.

It is obvious to the person skilled in the art that different changes and modifications may be made without departing from the scope of the present invention. In particular, the present invention may be used with a variety of different communication environments, such as HTML or VTML environments, and a variety of protocols, such as the standard HTTP and SSL protocols. A variety of programming languages may be used to implement the present invention, such as well known JAVA languages, C++ or C, for the Application Program Interface, API.

In general, any of the technical features and/or embodiments described above and/or below may be combined into one embodiment. Alternatively or additionally any of the technical features and/or embodiments described above and/or below may be in separate embodiments. Alternatively or additionally any of the technical features and/or embodiments described above and/or below may be combined with any number of other technical features and/or embodiments described above and/or below to yield any number of embodiments.

Although some embodiments have been described and shown in detail, the invention is not restricted to them, but may also be embodied in other ways within the scope of the subject matter defined in the following claims. In particular, it is to be understood that other embodiments may be utilised and structural and functional modifications may be made without departing from the scope of the present invention.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A method of determining whether a purchase has been performed on a website for which a merchant and an acquirer has entered an agreement, the method comprising the steps of
Equipping at least one web-page associated with said website with at least one web-bug, said at least one web-bug enabling collection of information related to one or more customers visiting said website;
If said at least one web-page equipped with at least one web-bug is visited by a customer then storing a number of pieces of information from said at least one web-bug relating to said customer in a database, said number of pieces of information comprising a unique customer identifier and an identification of said at least one web-page equipped with at least one web-bug visited by said customer;
If a payment to an account associated with said website comprising said unique customer identifier is received from said merchant by said acquirer, then retrieving said stored number of pieces of information from said database using said unique customer identifier as a key;
Based on the retrieved number of pieces of information, determining whether said payment to said account was performed on said website.

2. A method according to claim 1 wherein said unique customer identifier comprise information from a cookie on a customer computer visiting said webpage equipped with one or more web-bugs and/or payment card information received from said customer during said payment.

3. A method according to claim 1 wherein said identification of said at least one web-page equipped with at least one web-bug comprises a URL representing said web-page.

4. A method according to claim 1 wherein the step of determining whether said payment to said account was performed on said website comprises the step determining whether said unique customer identifier is present in said database.

5. A method according to claim 1 wherein the method further comprises a step of associating information regarding said customer received from a plurality of web-bugs via said unique customer identifier.

6. A method according to claim 1 wherein at least one web-page associated with receiving customer payment information is equipped with at least one web-bug.

7. A system for determining whether a purchase has been performed on a website for which a merchant and an acquirer has entered an agreement, the system comprising
Means for equipping at least one web-page associated with said website with at least one web-bug, said at least one web-bug enabling collection of information related to one or more customers visiting said website;
Means for storing a number of pieces of information from at least one web-bug on at least one web-page visited by a customer in a database, said number of pieces of information comprising a unique customer identifier and an identification of said at least one web-page equipped with at least one web-bug visited by said customer;
Means for retrieving said stored number of pieces of information from said database using said unique customer identifier as a key if a payment to an account associated with said website comprising said unique customer identifier is received from said merchant by said acquirer;
Means for determining whether said payment to said account was performed on said website based on the retrieved number of pieces of information.

8. A system according to claim 7 wherein said unique customer identifier comprise information from a cookie on a customer computer visiting said webpage equipped with one or more web-bugs and/or payment card information received from said customer during said payment.

9. A system according to claim 7 wherein said identification of said at least one web-page equipped with at least one web-bug comprises a URL representing said web-page.

10. A system according to claim 7 wherein the means for determining whether said payment to said account was performed on said website are further adapted to determine whether said unique customer identifier is present in said database.

11. A system according to claim 7 wherein the system further comprises means for associating information regarding said customer received from a plurality of web-bugs via said unique customer identifier.

12. A system according to claim 7 wherein at least one web-page associated with receiving customer payment information is equipped with at least one web-bug.

13. A computer readable medium having stored thereon a computer program comprising program code adapted to cause a data processing system to perform the steps of the method according to claim 1 when said program code is executed by said data processing system.

14. A method according to claim 2 wherein said identification of said at least one web-page equipped with at least one web-bug comprises a URL representing said web-page.

15. A method according to claim 2 wherein the step of determining whether said payment to said account was performed on said website comprises the step determining whether said unique customer identifier is present in said database.

16. A method according to claim 2 wherein the method further comprises a step of associating information regarding said customer received from a plurality of web-bugs via said unique customer identifier.

17. A method according to claim 2 wherein at least one web-page associated with receiving customer payment information is equipped with at least one web-bug.

18. A system according to claim 8 wherein said identification of said at least one web-page equipped with at least one web-bug comprises a URL representing said web-page.

19. A system according to claim 8 wherein the means for determining whether said payment to said account was performed on said website are further adapted to determine whether said unique customer identifier is present in said database.

20. A system according to claim 8 wherein the system further comprises means for associating information regarding said customer received from a plurality of web-bugs via said unique customer identifier.
